(19) United States
(12) Patent Application Publication
(10) Pub. No.: US 2010/0248700 A1
(43) Pub. Date: Sep. 30, 2010

(54) MOBILE TERMINAL

(76) Inventor: Megumi Endou, Saitama (JP)

Correspondence Address: Mr. Jackson Chen, 6535 N. STATE HWY 161, IRVING, TX, 75039, US

(21) Appl. No.: 12/742,020

(22) PCT Filed: Nov. 26, 2008
(86) PCT No.: PCT/JP2008/071420

§ 371 Date: May 7, 2010

(30) Foreign Application Priority Data
Nov. 27, 2007 (JP) 2007-305258

(51) Int. Cl. H04W 4/02; G06F 17/30; H04W 64/00

(52) U.S. Cl. 455/414.1; 455/456.1; 707/758; 707/E17.014

(57) ABSTRACT

To provide an information processing device which transmits a mail to all the users when a mobile information processing terminal has reached to a check position. The information processing device acquires terminal position information indicating a position of a mobile information processing terminal. The device correlates plural pieces of address information expressing a mail address with check position information indicating a check position when storing the check position information. The device compares the acquired terminal position information to the check position information and transmits mail information including address information stored in correspondence with the check position information as information indicating the transmission destination mail address, according to the comparison result. Thus, the mail information can be transmitted to all the mail addresses indicated by the plural pieces of address information stored in correspondence with the check position information.

### TECHNICAL FIELD

The present invention relates to a mobile terminal that is provided with a function which detects a current position of a monitored subject and notifies the condition of the monitored subject.

### BACKGROUND ART

As an example of the mobile terminals, known is a mobile information processing device (mobile information processing terminal) having a GPS (Global Positioning System) which acquires information that shows a current position. Examples of the mobile information processing terminals are mobile telephones, PHSs (Personal Handyphone Systems), PDAs (Personal Data Assistance, Personal Digital Assistant), and portable game machines.

The mobile telephones as an example of the mobile terminals have become more multi-functionalized, and types of mobile telephones having a plurality of functions have been developed. Further, the rate of possessing the mobile telephone is extremely high, and the age groups using the mobile telephones are expanded from elementary and junior high school students to senior citizens. The mobile telephone plays an important role as a tool for checking the security of the family member outdoors and the family member who lives separately by utilizing the functions thereof. In particular, many cases the reason for the elementary and junior high school students to carry the mobile telephones is for the parents to check the security of their children. However, the functions of the mobile telephone are insufficient for the needs when the mobile telephone is used in order to check the security. An action such as making a contact when a user arrives at a destination on the outside is one way of using the mobile telephone that is used in a daily life. However, the contact partner in many cases is a fixed partner such as the user's workplace or home. In that case, such routine work gives a feeling of troublesomeness for the user.

Patent Documents 1 and 2 disclose techniques for adding functions of the mobile terminal. The technique disclosed in Patent Document 1 sets a destination and passing points and receives radio waves at those positions from a GPS satellite, and informs a communicating partner by an e-mail that a user has arrived at the destination at a point where the user arrives at the destination. The technique disclosed in Patent Document 2 sets a traveling route between a start point and a destination, and monitors whether or not a user is traveling along the traveling route. When the user travels out of the traveling route or stops the move temporarily on the traveling route, this technique informs such action to a monitoring side, and informs the monitoring side when the user arrives at the destination as well.

### Patent Document 1: Japanese Unexamined Patent Publication 2003-264615

### Patent Document 2: Japanese Unexamined Patent Publication 2005-286817

### DISCLOSURE OF THE INVENTION

### Problems to be Solved by the Invention

However, Patent Documents 1 and 2 are designed on condition that the user travels along the route connecting between the start point and the destination, so that it is not possible to judge whether or not the action of the user is proper when the user arrives at the destination through a route that is different from the route set in advance.

In patent Document 2, a permissible range is set for a deviation amount with respect to the set route by assuming that the user moves on the route deviated from the set route. However, when the user travels on the route deviated largely from the assumed route, it is not possible with this technique to judge whether or not this action taken by the user is proper. Thus, Patent Document 2 faces the same issue as that of Patent Document 1 in this respect.

Furthermore, with the techniques of Patent Documents 1 and 2 which monitor whether or not elementary or junior high school students safely arrive at their school, tutoring school, or the like after the students leave their houses or the students safely arrive at their houses after leaving the school or the tutoring school, the route information is important. Thus, when all the routes used daily are to be covered, the memory capacitance becomes enormous. Therefore, it becomes necessary to increase the storage capacity of the memory of the mobile telephones. However, considering the portability of the mobile telephones, there is a limit in increasing the storage capacity. When a limit is set for the storage capacity, it is not possible to judge whether or not the action taken by the user is proper if the user arrives at the destination by accidentally passing through a route that is eliminated by the set limitation. In that case, the monitoring side needs to check the safety of the person who is being monitored by using the mail function of the mobile telephone. Thus, there is a limit in monitoring that is conducted based on the route. In this case, if the place to be monitored is an underpopulated area, for example, the route information is not enough to satisfy the necessary and sufficient condition under the current circumstances. Therefore, with Patent Documents 1 and 2, there is a difference generated in the monitoring accuracy depending on the regional characteristics to be monitored.

Further, since the techniques of Patent Documents 1 and 2 conduct monitoring by route searching, highly accurate monitoring cannot be conducted if the person who is being monitored changes the route information that is different from the intention of the monitoring side or neglects to change the route information.

In a case where a destination is set as a nearby park and an occurrence of leaving the house is to be informed by a mail as a means for checking the health condition of the parents living separately, the important thing is not the route to the destination but whether or not the parents have gone to the destination. Thus, a monitoring method which places great importance on the route to the destination such as the techniques of Patent Document 1 or 2 is not suited for such case. Further, with the currently developed mobile telephones, it is necessary to start the mail function of the mobile telephone when the user arrives at the station at which the user oneself is to get off from a train when going back home, and to write a mail and transmit it thereafter.

An object of the present invention is to automatize the routine work in using a mobile terminal used daily, and to provide a mobile terminal and the like with which the user can be relieved from troublesome work.

### Means for Solving the Problems

In order to achieve the foregoing object, the mobile terminal according to the present invention is a mobile terminal having a function of acquiring current position information. The mobile terminal includes: an information storage device which stores position information of a destination, contents information showing a condition of the mobile terminal at a position of the destination, and information of a mail address of a transmission partner in a related manner; a current position information monitoring device which compares the position information of the destination set in advance with current position information, and outputs a matching signal when the both match with each other; and a communication control unit which controls to transmit the position information of the destination and the contents information showing the condition of the mobile terminal at the destination to the mail address based on the matching signal outputted from the current position information monitoring device, wherein the current position information monitoring device and the communication control unit start to activate by having activation of a current position information positioning function of the mobile terminal as a trigger.

In the above, a case of building the present invention as a mobile terminal as hardware has been described. However, the present invention is not limited only to such case. The present invention may be built as a communication system or communication method which detects a current position of a monitored subject and informs the condition of the monitored subject, or may be built as a program for enabling control to detect a current position of a monitored subject and inform the condition of the monitored subject.

The communication system according to the present invention is a communication system which includes a mobile terminal and an information processing device which communicates with the mobile terminal. The mobile terminal has a function of acquiring position information of a destination and current position information of the mobile terminal and transmitting the acquired information to the information processing device. The information processing device includes:

an information storage device which stores the position information of the destination transmitted from the mobile terminal, contents information showing a condition of the mobile terminal at a position of the destination, and information of a mail address of a transmission partner in a related manner; a current position information monitoring device which compares the position information of the destination set in advance with current position information, and outputs a matching signal when the both match with each other; and a communication control unit which controls to transmit the position information of the destination and the contents information showing the condition of the mobile terminal at the destination to the mail address based on the matching signal outputted from the current position information monitoring device, wherein the current position information monitoring device and the communication control unit start to activate by having activation of a current position information positioning function of the mobile terminal as a trigger.

The communication method is a communication method for conducting communication by using a mobile terminal having a function of acquiring current position information, and the method executes: processing which compares position information of a destination set in advance with the current position information, and outputs a matching signal when the both match with each other; processing which transmits the position information of the destination and contents information showing a condition of the mobile terminal at the destination to a mail address based on the matching signal; and processing which starts the processing by having activation of a current position information positioning function of the mobile terminal as a trigger.

The communication program according to the present invention is a communication program for controlling communication conducted by using a mobile terminal having a function of acquiring current position information, and the program causes a computer to execute: a function which compares position information of a destination set in advance with the current position information, and outputs a matching signal when the both match with each other; a function which transmits the position information of the destination and contents information showing a condition of the mobile terminal at the destination to a mail address based on the matching signal; and a function which starts the functions by having activation of a current position information positioning function of the mobile terminal as a trigger.

### Effects of the Invention

With the present invention, activation of each function is started by having the activation of the current position information positioning function of the mobile terminal as a trigger, and the condition of the mobile terminal at the destination is informed to the transmission partner by having the positioning of the destination done by the positioning function as a trigger. Therefore, through storing in advance the position information of the destination, the contents information showing the condition of the mobile terminal at the destination, and the information of the mail address of the transmission partner in a related manner, the user can inform the condition at the destination to the transmission partner by simply conducting an easy operation of activating the positioning function. As a result, the routine work in using the mobile terminal used daily can be automatized, so that the user can be relieved from the troublesome work.

### BEST MODES FOR CARRYING OUT THE INVENTION

Hereinafter, exemplary embodiments of the invention will be described in detail by referring to the drawings.

### Exemplary Embodiments

FIG. 1 shows a mobile terminal according to an exemplary embodiment of the invention. In FIG. 1, a mobile telephone 1 is used as the mobile terminal. However, a mobile terminal other than the mobile telephone 1, such as a PHS (Personal Handyphone System), a PDA (Personal Data Assistance, Personal Digital Assistant), or a portable game machine, may also be used as the mobile terminal.

As shown in FIG. 1, the mobile telephone 1 as the mobile terminal according to the exemplary embodiment of the invention detects whether or not a user who carries the mobile telephone 1 has arrived at a destination and informs the condition of the mobile telephone 1 at the destination to a transmission partner by having the detection of the arrival as a trigger through using a mail transmitting function that is provided to the mobile telephone 1. Specifically, the mobile telephone 1 as the mobile terminal according to the exemplary embodiment of the invention starts activation of each function by having activation of a current position information positioning function of the mobile terminal as a trigger, and informs the condition of the mobile terminal at the destination to the transmission partner by having the positioning of the destination done by the positioning function as a trigger.

As shown in FIG. 1, a mail transmission device according to the exemplary embodiment of the invention includes: a control unit 10; a transmission/reception unit 20; a GPS signal processing unit 30; a sound signal processing unit 40; an input unit 50; and a display unit 60. In FIG. 1, the GPS signal processing unit 30 which acquires current position information by receiving radio waves from a GPS satellite is used as a measure for acquiring the destination of the mobile telephone 1 and the information of the current position of the mobile telephone 1. However, the current position information acquiring device may be something other than the GPS signal processing unit 30, as long as it is possible to acquire the destination of the mobile telephone 1 and the information of the current position of the mobile telephone 1. Further, if the mobile telephone 1 has the GPS signal processing unit 30, the already-provided GPS signal processing unit 30 may be utilized for that.

The radio signal processing unit 20 exchanges information with an information processing device (a base station in the case of the mobile telephone 1) as shown in FIG. 7 which relays the mobile telephone 1 and a mail transmission partner via a radio antenna 21. The radio signal processing unit 20 generates a transmission signal based on the transmission information from a mail transmission unit 77 (by modulating the signal showing the transmission information), and transmits the generated transmission signal to the base station, not shown, via the radio antenna 21. Further, the radio signal processing unit 20 receives a reception signal from the base station, not shown, via the radio antenna 21, acquires reception information based on the received reception signal (by demodulating the reception signal), and transmits the acquired reception information to a reception signal processing unit, not shown, of the control unit 10. The reception signal processing unit is an already-provided structure that is mounted to the mobile telephone 1, and there is no specific feature of the exemplary embodiment of the invention in that structure. Thus, explanations of a specific example thereof are omitted.

The GPS signal processing unit 30 is switched to an operating state in accordance with startup command information inputted by a user from the input unit 60, and switched to a non-operating state in accordance with stop command information inputted by the user from the input unit 60.

Furthermore, when the GPS signal processing unit 30 is in an operating state, the GPS signal processing unit receives the GPS signals from a plurality of GPS satellites, not shown, via a GPS antenna 31, and converts the current position information of the mobile telephone 1 to the information of latitude and longitude based on the received GPS signals (by demodulating the GPS signals).

A microphone 41 and a speaker 42 are connected to the sound signal processing unit 40. The microphone 41 outputs an input sound signal showing the sound of the surroundings of the microphone 41. The sound signal processing unit 40 generates input sound information based on the input sound signal outputted by the microphone 41 (by converting the input sound signal), and transmits the generated input sound information to the control unit 10.

Further, the sound signal processing unit 40 generates an output signal based on output sound information from the control unit 10 (by converting output sound information), and transmits the generated output sound signal to the speaker 42. The speaker 42 outputs the sound indicated by the output sound signal from the sound signal processing unit 40 to the outside the speaker 42.

Furthermore, the control unit 10 transmits controlling transmission information to the transmission/reception unit 20 and also receives controlling reception information from the transmission/reception unit 20 for establishing a sound communication connection or a data communication connection with the base station, not shown.

When the sound communication connection is established, the control unit 10 transmits the input sound information from the sound signal processing unit 40 to the radio signal processing unit 20 as transmission information. Further, when the sound communication connection is established, the control unit 10 generates the output sound information based on the reception information from the radio signal processing unit 20, and transmits the generated output sound information to the sound signal processing unit 40. With such structure, the user of the mobile telephone 1 can have conversational communications via the microphone 41 and the speaker 42, when the sound communication connection is established.

The input unit 60 includes a plurality of keys (button-type switches), not shown. The input unit 60 outputs operated input information corresponding to each key, when those keys are operated by the user.

The display unit 50 includes a screen, not shown. The display unit 50 displays images formed with characters, figures, and the like on the screen based on image information from the control unit 10.

Further, when the data communication connection is established, the control unit 10 generates mail information based on mail basic information stored in a recording medium, and transmits the generated mail information as transmission information to the transmission/reception unit 20. Furthermore, when the data communication connection is established, the control unit 10 generates reception mail information based on reception information from the transmission/reception unit 20, and stores the generated reception mail information to the recording medium.

The control unit 10 is a main part of the mail transmission device according to the exemplary embodiment of the invention, and a specific example thereof will be described by referring to FIG. 2.

The control unit 10 is created as a structure shown in FIG. 2, when it is built as hardware. When the exemplary embodiment of the invention is created as a communication program as software, the functions of the control unit 10 shown in FIG. 1, i.e., the functions of the structure shown in FIG. 2, may be executed by using a CPU (computer) 11 and a memory 12 to execute the communication program by the CPU 12 through reading the communication program stored in the memory 12 by the CPU 11. In explanations provided below, described is a case where the exemplary embodiment of the invention is built as hardware.

As shown in FIG. 2, the control unit 10 includes: a mail basic information reception unit 71, a check position information reception unit 72; a correlation information reception unit 74; an information storage unit 73; an deleting information reception unit 75; an information deleting unit 76; a current position information monitoring unit 70; a communication control unit 77a; a mail transmission unit 77; and a transmission successful-or-not information output unit 78.

For the mail transmission unit 76, a mechanism for transmitting mails provided to the mobile telephone 1 may be utilized. Further, for the information storage unit (information storage device) 80, a recording medium provided to the mobile telephone 1 may be utilized.

The mail basic information reception unit 71 receives information inputted by the user by using the input unit 60, i.e., contents information showing the condition of the mobile telephone 1 at the destination, and stores the contents information to the information storage unit 73. The contents information contains address information showing the mail address of the transmission partner, title information showing the title of the mail, and information showing the condition of the mobile telephone 1 at the destination such as text information showing the text of the mail. The condition of the mobile telephone 1 means the things that explain the state of the user, e.g., the user has arrived at the destination while carrying the mobile telephone 1.

The check position information reception unit 72 receives the position information of the mobile telephone 1 at the destination inputted by the user by using the input unit 60, and stores the position information to the information storage unit 73. The GPS signal processing unit 30 receives the radio waves from the GPS satellites, converts the current position information of the mobile telephone 1 to the latitude and longitude information, and displays it on the screen of the display unit 50. The user shifts the position information (map information, for example) displayed on the screen of the display unit 50 to the position information of the destination the user is heading by using the input unit 60, and points the destination. Upon this, the input unit 60 outputs the position information of the destination pointed by the user to the check position information reception unit 72 as the latitude and longitude information. The check position information reception unit 72 converts the position information of the mobile telephone 1 at the destination inputted from the input unit 60 to the latitude and longitude information, and receives it as the position information of the destination.

The correlation information reception unit 74 links the contest information received at the mail basic information reception unit 71 to the position information of the mobile telephone 1 at the destination received at the check position information reception unit 72 based on the operation information inputted by the user by using the input unit 60, and stores the linked information to the information storage unit 73. Further, the correlation information reception unit 74 displays, on the screen of the display unit 60, correlation information which shows the correlation between the check position information stored in the information storage unit 73 and the mail basic information stored in the information storage unit 73.

The correlation information reception unit 74 links the contents information to the position information of a plurality of destinations or links the contents information to the position information of a single destination based on the operation information inputted by the user by using the input unit 60. When linking the contents information to the position information of the destination, the correlation information reception unit 74 selects the address information of the transmission partner contained in the contents information based on the operation information inputted by the user by using the input unit 60, and links one, two, or more pieces of address information as the transmission partner.

The current position information monitoring device 70 compares the position information of the destination stored in the information storage device 73 with the current position information of the mobile telephone 1 detected by the GPS signal processing unit 30, and outputs a matching signal when the both match with each other.

The communication control unit 77a receives the matching signal outputted by the current position information monitoring device 70, and executes control to transmit the position information of the destination stored in the information storage unit 73 and the contents information showing the condition of the mobile telephone 1 at the destination to the mail address that is linked by the correlation information reception unit 74. Upon receiving the information from the communication control unit 77a, the mail transmission unit 77a transmits the information to the radio signal processing unit 20.

Specifically, the current position information monitoring device 70 judges whether or not the terminal position (position of the mobile telephone 1) indicated by the terminal position information is within a prescribed region (in this case, a region within a radius of 50 m with respect to the check position) which covers the check position shown in the check position information based on the terminal position information from the GPS signal processing unit 30 and the check position information stored in the information storage unit 73.

Further, upon judging that the terminal position is within the above-described region, the current position information monitoring device 70 outputs a matching signal.

Upon receiving the matching signal outputted by the current position information monitoring unit 70, the communication control unit 77a acquires the mail basic information which is stored in the information storage unit 73 by being related to the check position information based on the check position information and the correlation information stored in the information storage unit 73.

In addition, the communication control unit 77a transmits the acquired information to the mail transmission unit 77. The mail transmission unit 77 transmits the controlling transmission information to the radio signal processing unit 20 and receives the controlling reception information from the radio signal processing unit 20 so as to establish the data communication connection with the base station, not shown. Then, the mail transmission unit 77 generates mail information based on the acquired mail basic information, and transmits the generated mail information to the radio signal processing unit 20 as the transmission information.

Upon receiving the mail basic information from the mail basic information reception unit 71, the information storage unit 73 additionally stores the received mail basic information. Further, upon receiving the check position information from the check position information reception unit 72, the information storage unit 73 additionally stores the received check position information.

In the meantime, upon receiving the correlation information from the correlation information reception unit 74, the information storage unit 73 additionally stores the received correlation information. With such structure, a plurality of pieces of mail basic information can be related to a single piece of check position information and stored.

The deleting command information reception unit 75 receives deleting command information indicating a command for deleting the check position information stored in the information storage unit 73 inputted by the user by using the input unit 60, and outputs that information to the information deleting unit 76. Further, the deleting command information reception unit 75 displays the received deleting command information on the screen of the display unit 60. The deleting command reception unit 75 generates the deleting command information based on the inputted operation input information, and transmits the generated deleting command information to the information deleting unit 76.

When the information deleting unit 76 receives (accepts) the deleting command information from the deleting command information reception unit 75, the information deleting unit 76 deletes the check position information stored in the information storage unit 75 based on the received deleting command information, and deletes the correlation information related to the check position information.

With such structure, when the terminal device is within the above-described region including the check position (i.e., in the vicinity of the check position), all the pieces of mail information is received based on the mail basic information stored by being related to the check position information showing the check position are transmitted. Further, the current position information monitoring device 70 can be considered as a function which compares the terminal position information from the GPS signal processing unit 30 with the check position information stored in the information storage unit 73, and transmits mail information which contains the address information stored by being related to the check position information as the information showing the mail address of the transmission partner based on the result of comparison.

When the transmission successful-or-not information output unit 78 does not receive reception completion information indicating that mail information regarding the transmission from the base station, not shown, during a period from the end of the transmission of the mail information done by the mail transmission unit 77 till a prescribed waiting time has passed (i.e., when transmission of the mail information is unsuccessful), the transmission successful-or-not information output unit 78 displays an image (outputs transmission successful-or-not information) on the display of the display unit 60 indicating that the transmission of the mail information has failed (not succeeded).

Next, an action of automatically notifying the fact that the user has arrived at the destination by using the mobile telephone 1 according to the exemplary embodiment of the invention will be described by referring to FIG. 6.

First, when the user starts the GPS signal processing unit 30 by using the input unit 50 in an initial state (step S1 in FIG. 6: YES), the GPS signal processing unit 30 activates the position information positioning function of the mobile telephone 1 (step S2 in FIG. 6). Then, the GPS signal processing unit 30 displays the current position information of the mobile telephone 1 on the screen of the display unit 50.

The user shifts map information, for example, displayed on the display unit 50 to the map information showing the point of destination by using the input unit 50 to indicate the destination on the screen of the display unit 30. Then, when the user determines the destination by using the input unit 60 (step S3 in FIG. 6: YES), the GPS signal processing unit 30 outputs the position information of the destination to the check position information reception unit 72 according to the command from the input unit 60. The check position information reception unit 72 converts the received destination position information to the latitude and longitude information, and stores that information to the information storage unit 73 (step S4 in FIG. 6). Specifically, as shown in FIG. 4, the check position information reception unit 72 adds check position information ID for identifying the received destination position information (check position information) 401, 402, and stores the position information along with the information of latitudes LATa, LATb and longitudes LNGa, LNGb showing the position information of the destinations in a related manner to the information storage unit 73 in a table form shown in FIG. 4.

Therefore, the user inputs as necessary the destination to which the user oneself is heading by using the input unit 60. It is assumed here that the check position information 401 indicates the position of “tutoring school A”, for example. That is, the latitude “LATa” and the longitude “LNGa” are the latitude and the longitude of the “tutoring school A”, respectively. Further, it is assumed here that the check position information 402 indicates the position of “park B”, for example. That is, the latitude “LATb” and the longitude “LNGb” are the latitude and the longitude of the “park B”, respectively.

Next, in a state where an initial image is displayed (initial state) (step S5 in FIG. 6: NO), the user activates the mail basic information reception unit 71 by using the input unit 60. When the user inputs operation information by using the input unit 60, the mail basic information reception unit 71 creates the mail basic information and stores that information to the information storage unit 73. Specifically, when the user inputs operation information by using the input unit 60, the mail basic information reception unit 71 adds the mail basic information ID for identifying the mail basic information, and puts the mail address information showing the transmission partner, the title information, and the mail text showing the condition of the mobile telephone 1 at the destination in a table form by corresponding those to the mail basic information ID, and stores the table as contest information 301-305 to the information storage unit 73 (steps S6 and S7 in FIG. 6).

In FIG. 3, a mail address “aaa@domain” is a mail address of a mobile telephone owned by a user “FNA”, a mail address “bbb@domain” is a mail address of a PC (personal computer) owned by a user “FNB”, a mail address “ccc@domain” is a mail address of a mobile telephone owned by a user “LNC”, and a mail address “ddd@domain” is a mail address of a mobile telephone owned by a user “FND”.

Then, the user executes an operation for linking the contents information 301-305 shown in FIG. 3, which are displayed on the screen of the display unit 50, to the position information of the mobile telephone 1 at the destination shown in FIG. 4 by using the display unit 60. When the user executes the linking operation by using the input unit 60, the correlation information reception unit 74 links the contents information 301-305 shown in FIG. 3 set by the user to the position information 401, 402 of the mobile telephone 1 at the destination shown in FIG. 4 (step S8 and S9 in FIG. 6), and stores that information to the information storage unit 73. Specifically, the correlation information reception unit 74 combines the mail basic information IDs for identifying the contents information 301-305 shown in FIG. 3 set by the user with the check position information IDs for identifying the position information 401, 402 of the mobile telephone 1 at the destination shown in FIG. 4 to link the contents information 301-305 shown in FIG. 3 to the position information 401, 402 of the mobile telephone 1 at the destination shown in FIG. 4, and stores that information to the information storage unit 73 in a table form as shown in FIG. 5.

Through executing the process of above-described processing, a preparation for starting the action of automatically informing that the user has arrived at the destination by using the mobile telephone 1 according to the exemplary embodiment of the invention can be completed. When the preparation is completed or the information shown in FIG. 3, FIG. 4, and FIG. 5 is stored in the information storage unit 73, processing described below is executed by the mobile telephone 1.

When the user activates the GPS signal processing unit 30 by using the input unit 60, the current position information monitoring unit 70, the communication control unit 77a, the mail transmission unit 77, and the transmission successful-or-not information output unit 78 are activated to be in a standby state by having the activation of the GPS signal processing unit 30 as a trigger.

When the user moves while carrying the mobile telephone 1 (step S10 in FIG. 6), the GPS signal processing unit 30 detects the current position of the mobile telephone 1 by receiving radio waves from the GPS satellites, and outputs the position information to the current position information monitoring unit 70. Upon receiving the current position information of the mobile telephone 1 from the GPS signal processing unit 30, the current position information monitoring unit 70 successively reads out the position information of the mobile telephone 1 at the destinations shown in FIG. 4 stored in the information storage unit, and compares whether or not there is information shown in FIG. 4 which matches the current position information of the mobile telephone 1 (step S11 in FIG. 6).

When the current position information of the mobile telephone 1 detected by the GPS signal processing unit 30 matches with the position information of the mobile telephone 1 at the destination shown in FIG. 4 read out from the information storage unit 73, the current position information monitoring unit 70 outputs a matching signal to the communication control unit 77a (step S12 in FIG. 6: YES, step S13).

When the current position information monitoring unit 70 outputs the matching signal, the communication control unit 77a receives the matching signal, and starts control to inform the transmission partner that the user has arrived (step S14 in FIG. 6). Specifically, upon receiving the matching signal, the communication control unit 77a searches stored information of the information storage unit 73 and searches the mail basic information ID which corresponds to the check position information ID for identifying the position information of the designation the user has arrived by using the information shown in FIG. 5 so as to search the mail basic information shown in FIG. 3 which corresponds to the searched ID. Then, the communication control unit 77a reads out the position information of the mobile telephone 1 at the destination shown in FIG. 4 corresponding to the matching signal and the corresponding contents information show in FIG. 3, searches the mail address of the transmission partner from the contents information, and transmits the mail address information, the position information at the destination, and the contents information to the mail transmission unit 77.

Upon receiving the mail address information, the position information at the destination, and the contents information from the communication control unit 77a, the mail transmission unit 77 transmits the position information at the destination and the contents information to the set mail address (step S15 in FIG. 6).

When the transmission by the mail transmission unit 77 is successfully completed, the transmission successful-or-not information output unit 78 displays “transmission completed” on the screen of the display unit 50 (step S16 in FIG. 6). When the transmission by the mail transmission unit 77 is not completed, the transmission successful-or-not information output unit 78 displays “transmission uncompleted” on the screen of the display unit 50. The contents displayed by the transmission successful-or-not information output unit 78 regarding completion or incompletion of the transmission are not limited to the aforementioned ones.

The person who receives the mail at the transmitted side displays the transmitted position information at the destination and the contents information on the screen to check that the user who carries the mobile telephone 1 has arrived at the destination.

When the user who has arrived at the destination while carrying the mobile telephone 1 checks on the display unit 50 of the mobile telephone 1 that the transmission has been completed, the user executes next processing. That is, when the arrived position of the mobile telephone 1 set by the user, i.e., the destination, is a place to which the user goes daily and it is a place required to transmit a mail when the user arrives that destination, the user maintains the information stored in the information storage unit 73. Further, when it is necessary to eliminate the information, the user activates the deleting information reception unit 75 and the information deleting unit 76 by using the input unit 60 to eliminate the corresponding information from the information storage unit 73.

As described above, the exemplary embodiment of the invention starts activation of each function by having activation of a current position information positioning function of the mobile terminal as a trigger, and informs the condition of the mobile terminal at the destination to the transmission partner by having the positioning of the destination done by the positioning function as a trigger. Thus, through storing in advance the position information of the destination, the contents information showing the condition of the mobile terminal at the position of the destination, and the mail address information of the transmission partner in a related manner, the user can inform the condition at the destination to the transmission partner by simply conducting an operation of activating the positioning function. Therefore, the routine work in using a mobile terminal used daily can be automatized, so that the user can be relieved from the troublesome work.

Further, when the user arrives at the destination, it is possible to automatically transmit a mail saved in advance without any operation done by the user. Furthermore, while the mail is automatically transmitted, the result of mail transmission, i.e., whether it is successful or unsuccessful, is displayed on the display screen. Thus, the user who sets the automatic mail transmission can also check the transmission state.

Further, through executing in advance an operation of creating and saving the destination and a mail to be transmitted when the user arrives at the destination, the mail can be transmitted automatically when the user arrives at the destination. This makes it possible to accurately notify the partner that the user has arrived at the destination. Furthermore, this makes it possible to prevent the user from forgetting transmission of a notification. Thereby, when an elementary school student as the user arrives at school, at a tutoring school, at home, for example, a mail is transmitted to the mail transmission partner that is the parent, on condition that it is so set in advance. With such mail, it is possible to use the mobile telephone directed to checking the security of the elementary school student as the user. Further, the parent as the mail transmission partner can be relieved since the mail can be transmitted automatically even the parent oneself does not make an action to acquire the position information of the child. Similarly, it is also possible to know whether or not parents who live separately go out of the house by using a mail through setting a nearby park as the destination as a measure for checking the health conditions of the parents.

Furthermore, through executing in advance an operation of creating and saving the destination and a mail to be transmitted when the user arrives at the destination, it becomes possible to transmit a notification by a mail automatically that the user has safely arrived at a target office or station. This makes it possible to relieve the user from the troublesome. Further, it is also possible to use the mobile telephone to notify the family that the user is on the way home by setting the station at which the user oneself gets off when the user goes home by train as the destination.

In the exemplary embodiment shown in FIG. 1-FIG. 6, all the structures required for sending a notification by mail transmission are mounted to the mobile terminal side. However, the present invention is not limited only to such case. As the exemplary embodiment of the invention, it is possible to build it as a communication system including a mobile terminal 1A and an information processing device 90 which communicate with the mobile terminal 1A. When the mobile terminal 1A is a mobile telephone, the information processing device 90 corresponds to a base station which relays communications. The mobile terminal 1A shown in FIG. 7 corresponds to the mobile terminal 1 shown in FIG. 1.

When the exemplary embodiment of the invention is built as the communication system, the communication system is designed to include the mobile terminal 1A and the information processing device 90 which communicates with the mobile terminal 1A as shown in FIG. 7.

Further, the mobile telephone 1A is structured to include a GPS signal processing unit 30, an input unit 60, and a radio signal processing unit 20, and to have a function which acquires the position information of the destination and the current position information of the mobile terminal, and transmits the information to the information processing device.

Further, the information processing device 90 includes a control unit 92 corresponding to the control unit 10 shown in FIG. 1 and a transmission/reception unit 91. Specifically, the information processing device 90 is built as a structure which includes: an information storage unit 73 which stores position information of the destination transmitted from the mobile terminal, contents information showing the condition of the mobile terminal at the position of the destination, and mail address information of the transmission partner in a related manner; a current position information monitoring device 70 which compares the position information of the destination set in advance with the current position information, and outputs a matching signal when the both match with each other; and a communication control unit 77a which executes control to transmit the position information of the destination and the contents information showing the condition of the mobile terminal at the destination to the mail address according to the matching signal outputted by the current position information monitoring device. Further, the current position information monitoring unit 70 and the communication control unit 77a are built as the structure which starts to activate by having the activation of the positioning function of the current position information of the mobile terminal as a trigger. Other structures and the action for transmitting a mail when the user arrives at the destination are the same as those of the exemplary embodiment shown in FIG. 1 and FIG. 2.

With the communication system shown in FIG. 7, mail information is transmitted by the base station 90 to all of a plurality of users when the mobile telephone 1A arrives at the check position (in the vicinity thereof), as in the case of the above-described exemplary embodiment. As a result, it is possible to immediately inform all of the plurality of users that the monitored user who carries the mobile telephone 1A has arrived at the check position.

Next, another exemplary embodiment of the invention will be described by referring to FIG. 8-FIG. 9. In the exemplary embodiment shown in FIG. 8, the structures of the current position information monitoring unit 70 and the communication control unit 77a shown in FIG. 2 are mounted into the mail transmission unit 77, and the mail transmission unit 77 is structured to execute the both functions of the current position information monitoring unit 70 and the communication control unit 77a shown in FIG. 2. Each of the structures shown in FIG. 8 executes the same functions as those of the structures shown in FIG. 2.

Next, actions of the mobile telephone 1 shown in FIG. 8 will be described in a specific manner.

A CPU 11 of the mobile telephone 1 executes a basic program, not shown, to display a list of a plurality of programs, and provides an image (initial image) containing a menu capable of selecting a single program from the list on the display of the display unit 60. These programs include a mail basic information input program, a check position information input program, a correlation information input program, an information deleting program, and an at-arrival mail transmission program (see FIG. 9) to be described later. When operation input information to select a single program within the menu is inputted, the CPU 11 starts execution of the selected program. When the execution of that program ends, the CPU 11 displays the initial image again.

The CPU 11 executes the mail basic information input program, not shown, to provide, on the display of the display unit 60, an image including an input unit for inputting the address information, an input unit for inputting title information, and an input section for inputting text information. Further, the CPU 11 switches the input section as the input target according to the operation input information, and receives the inputted operation input information. Further, the CPU 11 additionally stores the mail basic information based on the received operation input information to the memory 12 by relating it to the mail basic information ID (integer incremented by 1 in order of the mail basic information stored in the memory 12 in this case) in accordance with the operation input information indicating that the input is completed. Then, the CPU ends the execution of the mail basic information input program. Execution of the mail basic information input program corresponds to a part of the mail basic information reception unit 71 and the information storage unit (information storage processing step) 73.

Therefore, when the user repeats the operation for selecting the mail basic information input program or the operation for inputting the mail basic information (input operation using the keys of the input unit 50) in the state where the initial image is displayed (initial sate), a plurality of pieces of mail basic information 301-305 can be stored to the memory 12 as shown in FIG. 3. A mail address “aaa@domain” is a mail address of a mobile telephone owned by a user “FNA”, a mail address “bbb@domain” is a mail address of a PC (personal computer) owned by a user “FNB”, a mail address “ccc@domain” is a mail address of a mobile telephone owned by a user “LNC”, and a mail address “ddd@domain” is a mail address of a mobile telephone owned by a user “FND”.

In the meantime, the CPU 11 executes the check position information input program, not shown, to provide an image including a map and a position selecting cursor indicating a single point within the map on the display of the display unit 60. Further, the CPU 11 shifts the position selecting cursor within the map according to the operation input information. Furthermore, the CPU 11 generates the check position information (latitude information showing the latitude of the check position and longitude information showing the longitude of the check position) based on the position of the position selecting cursor within the map in accordance with the operation input information indicating that selection of the position is completed. Then, the CPU 11 additionally stores the generated check position information to the memory 12 by relating it to the check position information ID (integer incremented by 1 in order of the mail basic information stored in the memory 12 in this case). Thereafter, the CPU 11 ends the execution of the check position information input program. Execution of the check position information input program corresponds to a part of the check position information reception unit 72 and the information storage unit (information storage processing step) 73.

Therefore, when the user repeats the operation for selecting the check position information input program or the operation for inputting the check position information (input operation using the keys of the input unit 50) in the initial state, a plurality of pieces of check position information 401, 402 can be stored to the memory 12 as shown in FIG. 4. The check position information 401 indicates the position of “tutoring school A”. That is, the latitude “LATa” and the longitude “LNGa” are the latitude and the longitude of the “tutoring school A”, respectively. Further, it is assumed here that the check position information 402 indicates the position of “park B”. That is, the latitude “LATb” and the longitude “LNGb” are the latitude and the longitude of the “park B”, respectively.

As described, the user can easily add new check position information through inputting the check position information.

Further, the CPU 11 executes the correlation information input program, not shown, to provide an image including two input sections on the display of the display unit 60. One input section is a section with which a list of the check position information stored in the memory 12 can be displayed and a single piece of check position information can be selected from the list. The other input section is a section with which a list of mail basic information stored in the memory 12 can be displayed and a single piece or a plurality of pieces of mail basic information can be selected from the list.

Further, the CPU 11 switches the input sections as the input target according to the operation input information, and receives the inputted operation input information. Further, the CPU 11 generates the same number of pieces of correlation information (information configured with a set of check position information ID and mail basic information ID) as the number of the selected mail basic information based on the received operation input information in accordance with the operation input information indicating that the input is completed, and additionally stores the generated correlation information to the memory 12. Then, the CPU 11 ends the execution of the correlation information input program. Execution of the correlation information input program corresponds to a part of the correlation information reception unit 74 and the information storage unit (information storage processing step) 73.

Therefore, when the user repeats the operation for selecting the correlation information input program or the operation for inputting the correlation information (input operation using the keys of the input unit 50) in the initial state, a plurality of pieces of correlation information 501-505 can be stored to the memory 12 as shown in FIG. 5.

Further, the CPU 11 executes the information deleting program, not shown, to display a list of check position information stored in the memory 12, and provide, on the display of the display unit 60, an image including an input section with which a single piece or a plurality of pieces of check position information can be selected. Further, the CPU 11 receives the inputted operation input information. Then, the CPU 11 deletes the selected check position information from the memory 12 based on the received operation input information (deleting command information) in accordance with the operation input information indicating that the input is completed, and also deletes the correlation information related to the selected check position information from the memory 12. Then, the CPU 11 ends the execution of the information deleting program. Execution of the information deleting program corresponds to the deleting command information reception unit 75 and the information deleting unit 76.

As described, the user can easily delete the check position information through inputting the deleting command information. In other words, the check position information is continuously remained being stored, unless the deleting command information is inputted. Therefore, compared to a case where check position information as the base for transmitting mail information is deleted immediately after transmitting that mail information, it is possible to save the time and effort for the user required for setting the check position information again. As a result, the convenience for the user can be improved.

Now, as shown in FIG. 3-FIG. 5, it is assumed that the monitored user “LNA” carrying (holding) the mobile telephone 1 moves to “park B” from “home” in a state where the check position information, the mail basic information, and the correlation information are stored in the memory 12.

In that case, first, the monitoring user “FNA” who desires to monitor the action of the monitored user “LNA” selects the at-arrival mail transmission program on the initial image. Thereby, the CPU 11 executes the at-arrival mail transmission program that is shown in a flowchart of FIG. 9. Execution of the at-arrival mail transmission program corresponds to the mail transmission unit (mail transmitting step) 77 and the transmission successful-or-not information output unit 78.

Specifically, upon starting the processing of the at-arrival mail transmission program, the CPU 11 transmits activation command information to the GPS signal processing unit 30 to switch the state of the GPS signal processing unit 30 to an operating state in step S605 when the GPS signal processing unit 30 is in a non-operating state.

Then, the CPU 11 receives terminal position information from the GPS signal processing unit 30 in step S610. Then, in step S615, the CPU 11 judges whether or not the acquired terminal position information matches with the check position information 401 or 402 stored in the memory 12. In this example, when the terminal position indicated by the terminal position information is within the region in a radius of 50 m with respect to the center of the check position information indicated by the check position information (i.e., the terminal position is in the vicinity of the check position), the CPU 11 judges that the terminal position information matches with the check position information.

At this point, the monitored user is at “home”. Thus, the terminal position is outside the above-described region, so that the CPU 11 judges “No” in step 615 and returns to step 610 after waiting for a prescribed little time. The CPU 11 repeatedly executes the processing of step 610 and step 615 until the terminal position reaches within the region.

Thereafter, the monitored user reaches to a position in the vicinity of “park B” (at a position that is 50 m from “park B”). In this state, the terminal position is within the above-described region. Thus, the CPU 11 judges as “Yes” in step 615, and proceeds to step 620. The at-arrival mail transmission program may contain processing which switches the state of the GPS signal processing unit 30 to a non-operating state when judged as “Yes” in step 615.

Then, the CPU 11 generates a list of mail basic information stored by being linked to the check position information 402 (showing the check position information matched with the terminal position) which is the basis for making judgment as “Yes” in step 615 by referring to the tables of FIG. 3-FIG. 5. Thus, at this point, the list configured with the mail basic information 303-305 is created.

Thereafter, in step 625, the CPU 11 judges whether or not there is mail basic information remained on the list. At this point, the CPU 11 makes judgment as “Yes”, and proceeds to step 630 where the CPU 11 acquires the first information (mail basic information 303) on the list, and deletes the mail basic information 303 from the list.

Then, the CPU 11 transmits controlling transmission information to the radio signal processing unit 20 and receives controlling reception information from the radio signal processing unit 20 to establish data communication connection with the base station, not shown, in step 635. Further, the CPU 11 generates mail information based on the acquired mail basic information 303. The mail information is the information which contains the address information within the mail basic information 303 as the information indicating the mail address of the transmission partner, and contains title information within the mail basic information 303 as the information showing the title of the mail and text information within the mail basic information 303 as the information showing the text of the mail (i.e., contains the contents information within the mail basic information 303 as the information showing the contents (title and text) of the mail). Further, the CPU 11 transmits the generated mail information to the radio signal processing unit 20 as the transmission information. Thereby, the mail information is transmitted to the base station, not shown.

The base station transmits the mail information to the mail address “aaa@domain” of the transmission partner via a communication line, not shown, (the Internet in this example). Thereby, the mobile telephone carried by the monitoring user “FNA” receives the mail information. As a result, the monitoring user “FNA” can view (receive) the mail containing the contents shown in the title information and the text information within the mail basic information 303.

As described, in a case where the position of the mobile telephone 1 matches with “park B” that is the check position (in this example, in a case where the position of the mobile telephone 1 has reached to the inside the prescribed region including “park B”, the mobile telephone 1 transmits the mail information which contains the address information stored by being related to the check position information as the information indicating the mail address of the transmission partner.

With this, when the monitored user “LNA” who carries the mobile telephone 1 arrives at an area in the vicinity of “park B”, the mail information can be transmitted from the mobile telephone 1 without the monitored user “LNA” conducting an operation for transmitting the mail information. As a result, the monitoring user “FNA” can immediately know that the monitored user “LNA” has arrived at “park B”. Further, the monitoring user “FNA” can know that the monitored user “LNA” has arrived at “park B” by simply checking the received mail without conducting an operation for checking the position of the monitored user “LNA” in particular. That is, the conveniences for the monitoring user “FNA” and the monitored user “LNA” can both be improved.

Then, the CPU 11 judges whether or not transmission of the mail information is completed successfully. In this example, the CPU 11 judges that the transmission of the mail information is succeeded when it receives reception completed information indicating that the mail information has been received from the base station, not shown, in a period after executing transmission of the mail information until a prescribed waiting time has passed.

Now, explanations will be continued assuming that the transmission of the mail information is succeeded.

In this case, the CPU 11 judges as “Yes” in step 640, returns to step 625, and repeatedly executes processing of step 625-step 640 until there is no more mail basic information remained within the list. That is, the CPU 11 transmits the mail information based on the mail basic information 304 and the mail information based on the mail basic information 305 in order. Thereby, the monitoring user “LNC” receives a mail containing the contents shown by the contents information within the mail basic information 304, and the monitoring user “FND” receives a mail containing the contents shown by the contents information within the mail basic information 305.

At this point, there is no mail basic information remained within the list. Therefore, when the CPU 11 advances to step 625, the CPU 11 judges as “No” and directly advances to step 699 to end the execution of this program.

As described, when the monitored user “LNA” carrying the mobile telephone 1 arrives at an area in the vicinity of “park B” that is the check position, the mobile telephone 1 transmits the mail information to each of the mail addresses indicated by a plurality of pieces of address information stored by related to “park B”. That is, even when there are a plurality of users desired to transmit a notification that the monitored user “LNA” has arrived at the check position “park B”, the mail information can be transmitted to all of the plurality of users (“FNA”, “LNC”, and FND″). As a result, it is possible to immediately inform all of the plurality of users that the monitored user “LNA” has arrived at the check position.

Further, the mobile telephone 1 stores the contents information and the address information as a single piece of mail basic information (by relating the contents information to the address information). This makes it possible to transmit, to the plurality of monitoring users, a mail containing the proper contents in accordance with the respective monitoring users.

When transmission of the mail information is not succeeded (failed), the CPU 11 judges as “No” in step 640, and advances to step 645 to display an image on the display of the display unit 60 indicating that the transmission of the mail information is failed.

Thereby, the monitored user “LNA” carrying the mobile telephone 1 can know whether or not the transmission of the mail information is failed. With this, when the transmission of the mail information is failed, the monitored user “LNA” can operate the mobile telephone 1 to retransmit the mail, for example. As a result, it is possible to decrease the possibility of continue the state where the mail information is not transmitted even when the transmission of the mail information is failed.

Next, there is assumed a case where the monitored user “LNA” carrying the mobile telephone 1 moves to “tutoring school A” from “home” after returning to “home” once. In this case, as in the above-described case, the monitoring user “FNA” selects the at-arrival mail transmission program on an initial image. Thereby, the CPU 11 executes the at-arrival mail transmission program shown in FIG. 9.

Thus, when the monitored user “LNA” arrives at an area in the vicinity of “tutoring school A” (step 610 and step 615), the CPU 11 generates a list configured with the mail basic information 301, 302 stored by being related to the check position information 401 (showing the position of “tutoring school A”) (step 620). Further, the CPU 11 transmits the mail information based on the mail basic information 301 and the mail information based on the mail basic information 302 within the list in order (step 625-step 645).

As described above, the mobile telephone 1 stores a plurality of pieces of check position information. Thus, even if the user (monitoring user “FNA”, for example) does not conduct an operation for changing the check position information, a mail can be transmitted when the monitored user “LNA” reaches at each of the plurality of check positions. This makes it possible to improve the convenience for the user.

As described above, it is possible with the exemplary embodiment of the invention to transmit the mail information to all of the plurality of users when the mobile telephone (mobile information processing terminal) reaches at the check positions (including the areas in the vicinity thereof).

The present invention is not limited to the exemplary embodiment described above, and various modification examples can be employed within the scope of the present invention. For example, while the exemplary embodiment described above is structured to transmit the mail information from the mobile telephone 1, it is also possible to employ a structure which transmits the mail information from the base station.

The information processing system corresponding to a modification example of the exemplary embodiment includes a mobile telephone 1A having the functions shown in FIG. 7 and a base station 80. The base station 80 may be a server device such as a switch board connected to the base station.

The mobile telephone 1A includes the same structures as those of the mobile telephone 1 of the above-described exemplary embodiment. A transmission unit (terminal position information transmission device) 70 as a part of the function of the mobile telephone 1A transmits terminal position information from a GPS signal processing unit (terminal position information acquiring device) 30, check position information generated based on operation input information from an input unit 50, mail basic information, and correlation information to the base station 80, respectively.

The base station 80 is an information processing device which includes a CPU and a storage medium (a hard disk device, for example) as a memory and a storage device, not shown. Further, the base station 80 is structured to be communicable with the mobile telephone 1A. The base station 80 achieves the functions shown in FIG. 10 by executing the program stored in the storage medium with its CPU.

A reception unit (terminal position information reception device) 81 as a part of the function of the base station 80 receives the terminal position information, the check position information, the mail basin information, and the correlation information transmitted from the mobile telephone 1A.

Further, as other functional units of the basic station 80, a mail basic information reception unit 82, a check position information reception unit 83, an information storage unit (information storage device, information storage processing device) 84, a correlation information reception unit 85, an deleting command information reception unit 86, an information deleting unit 87, and a mail transmission unit (mail transmission device) 88 corresponding respectively to the mail basic information reception unit 71, the check position information reception unit 72, the information storage unit 73, the correlation information reception unit 74, the deleting command information reception unit 75, the information deleting unit 76, and the mail transmission unit 77 of the above-described exemplary embodiment are provided.

That is, the information storage unit 84 of the base station 80 stores the check position information, the mail basic information, and the correlation information received by the reception unit 81. That is, the information storage unit 84 can be considered a function which stores the check position information and also stores a plurality of pieces of address information by relating those to the check position information.

Further, the mail transmission unit 88 of the base station 80 compares terminal position information received by the reception unit 81 with the check position information stored in the information storage unit 84, and transmits mail information which contains the address information stored by being related to the check position information as the information indicating the mail address of the transmission partner based on the result of comparison.

With the information processing system, as in the case of the above-described exemplary embodiment, it is possible to transmit the mail information to all of the plurality of users by the base station 80 when the mobile telephone 1A reaches at the check positions (including the areas in the vicinity thereof). This makes it possible to immediately inform all of the plurality of users that the monitored user carrying the mobile telephone 1A has reached at the check position.

Further, while the mobile information processing terminal is the mobile telephone 1 in the above-described exemplary embodiment, the mobile information processing terminal may be a PHS, a PDA, or a portable game machine as long as it is a mobile (portable) terminal. Furthermore, while the base station is structured to transmit the mail information via the Internet in the above-described exemplary embodiment, it is also possible to employ a structure with which the base station directly transmits the information to the mobile telephone whose mail address is known to the base station. That is, the mail in the above-described exemplary embodiment may be an electronic mail or a mobile-telephone mail.

In addition, while the contents information is the title information and the text information in the above-described exemplary embodiment, the contents information may contain sound information and/or figure information and the like in addition or instead of the title information and the text information.

Further, while the above-described exemplary embodiment is structured to acquire the terminal position information based on the GPS signals from a plurality of GPS satellites, it is also possible to employ a structure with which the terminal position information is acquired based on the signals from the base stations (e.g., intensity or the like of the signals from a plurality of base stations). Furthermore, while the above-described exemplary embodiment is structured to acquire the terminal position information by the mobile telephone 1, it is also possible to employ a structure with which the base station acquires the terminal position information based on the signal from the mobile telephone.

Still another exemplary embodiment of the invention will be described. Another exemplary embodiment of the invention is an information processing device including a terminal position information acquiring device for acquiring terminal position information showing a position of a mobile information processing terminal, and the information processing device may include:

an information storage device which stores check position information showing a check position by relating a plurality of pieces of address information indicating mail addresses; and
a mail transmission device which compares the acquired terminal position information with the check position information, and transmits mail information containing the address information stored by being related to the check position information as information indicating the mail address of a transmission partner based on a result of the comparison.

In the information processing device, the information storage device may be structured to further store contents information showing contents of the mail, and the mail transmission device may be structured to transmit the mail information containing the contents information.

Further, in the information processing device, the information storage device may be structured to store a plurality of pieces of the contents information and may also be structured to store the contents information by relating it to the address information.

Furthermore, the information processing device may include a check position information reception device which receives the check position information that is inputted, wherein the information storage device may be structured to store the received check position information.

Further, the information storage device may be structured to be able to store a plurality of pieces of the check position information. Furthermore, it is also possible to include a transmission successful-or-not information output device which outputs transmission successful-or-not information indicating that transmission of the mail information is failed, when the transmission of the mail information by the mail transmission device is failed. It is also possible to include a deleting command information reception device which receives inputted deleting command information, and an information deleting device which deletes the stored check position information when the deleting command information reception unit receives the deleting command information. As the information processing device, the mobile information processing terminal may be used as well.

Another exemplary embodiment of the invention is a mail transmission method for transmitting mail information to an information processing device, and the method may be structured to include: an information storage processing step which stores check position information showing a check position and a plurality of pieces of address information mail addresses to a storage device in a related manner; a terminal position information acquiring step which acquires terminal position information showing a position of a mobile information processing terminal; and a mail transmitting step which compares the acquired terminal position information with the check position information, and transmits mail information containing the address information stored by being related to the check position information as information indicating the mail address of a transmission partner based on a result of the comparison.

The information storage processing step may be structured to include a step which stores contents information showing contents of the mail to the storage device, and the mail transmitting step may be structured to transmit the mail information containing the contents information. The information storage processing step may be structured to include a step which stores a plurality of pieces of the contents information to the storage device and to store the contents information by relating it to the address information.

Further, another exemplary embodiment of the invention may be structured as a mail transmission program which causes an information processing device to execute:

a terminal position information acquiring device for acquiring terminal position information showing a position of a mobile information processing terminal,
an information storage processing device which stores check position information showing a check position and a plurality of pieces of address information indicating mail addresses in a related manner; and
a mail transmission device which compares the acquired terminal position information with the check position information, and transmits mail information containing the address information stored by being related to the check position information as information indicating the mail address of a transmission partner based on a result of the comparison.

The information storage processing device may be structured to further store contents information showing contents of the mail to the storage device, and the mail transmission device may be structured to transmit the mail information containing the contents information. The information storage processing device may be structured to store a plurality of pieces of the contents information and may also be structured to store the contents information by relating it to the address information.

Further, another exemplary embodiment of the invention may be an information processing system including a mobile information processing terminal and an information processing device which communicates with the mobile information processing terminal.

The mobile information processing terminal may include: a terminal position information acquiring device which acquires terminal position information showing a position of the mobile information processing terminal; and a terminal position information transmission device which transmits the acquired terminal position information.

The information processing device may include: a terminal position information reception device which receives the transmitted terminal position information; an information storage device which stores check position information showing a check position and a plurality of pieces of address information indicating mail addresses in a related manner; and

a mail transmission device which compares the acquired terminal position information with the check position information, and transmits mail information containing the address information stored by being related to the check position information as information indicating the mail address of a transmission partner based on a result of the comparison.

The information storage processing device may be structured to further store contents information showing contents of the mail, and the mail transmission device may be structured to transmit the mail information containing the contents information. The information storage processing device may be structured to store a plurality of pieces of the contents information and may also be structured to store the contents information by relating it to the address information.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2007-305258 filed on Nov. 27, 2007 and the disclosure thereof is hereby incorporated by reference in its entirety.

### INDUSTRIAL APPLICABILITY

The present invention is applicable to the information processing system which informs the position of a mobile telephone carried by a user to another user.

### BRIEF DESCRIPTION OF THE DRAWINGS

FIG. 1 is a block diagram showing a schematic illustration of structures of a mobile telephone;

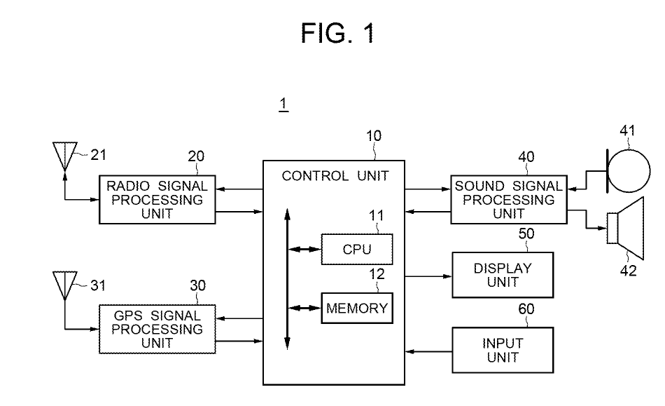

FIG. 2 is a block diagram showing a schematic illustration of functions of the mobile telephone;

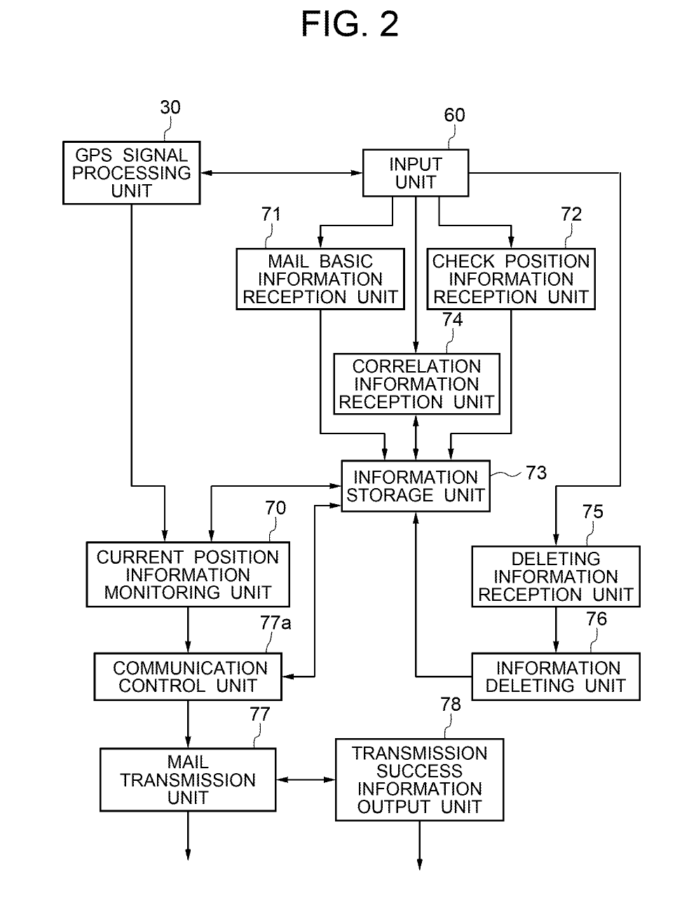

FIG. 3 is a table showing mail basic information stored in a memory shown in FIG. 1;

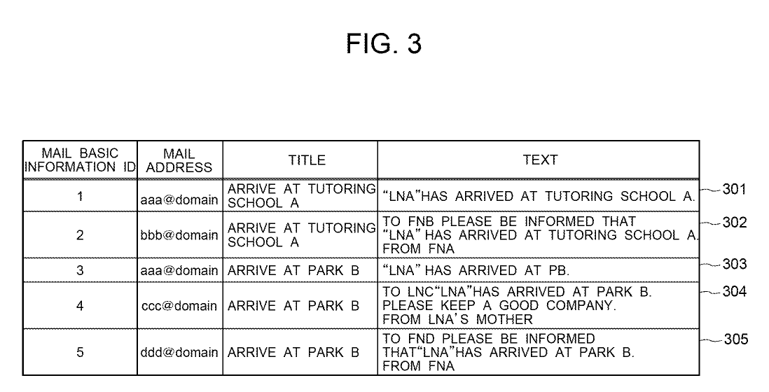

FIG. 4 is a table showing check position information stored in the memory shown in FIG. 1;

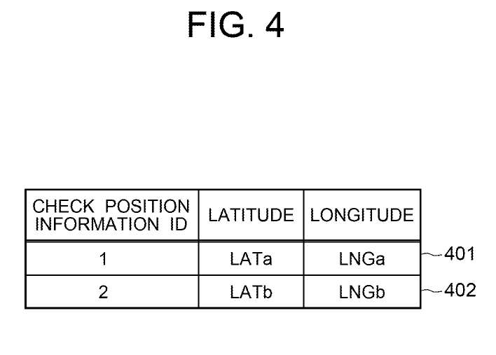

FIG. 5 is a table showing correlation information stored in the memory shown in FIG. 1;

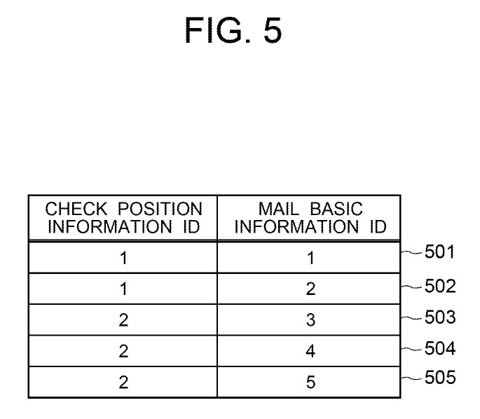

FIG. 6 is a flowchart showing an at-arrival mail transmission program executed by a CPU shown in FIG. 1;

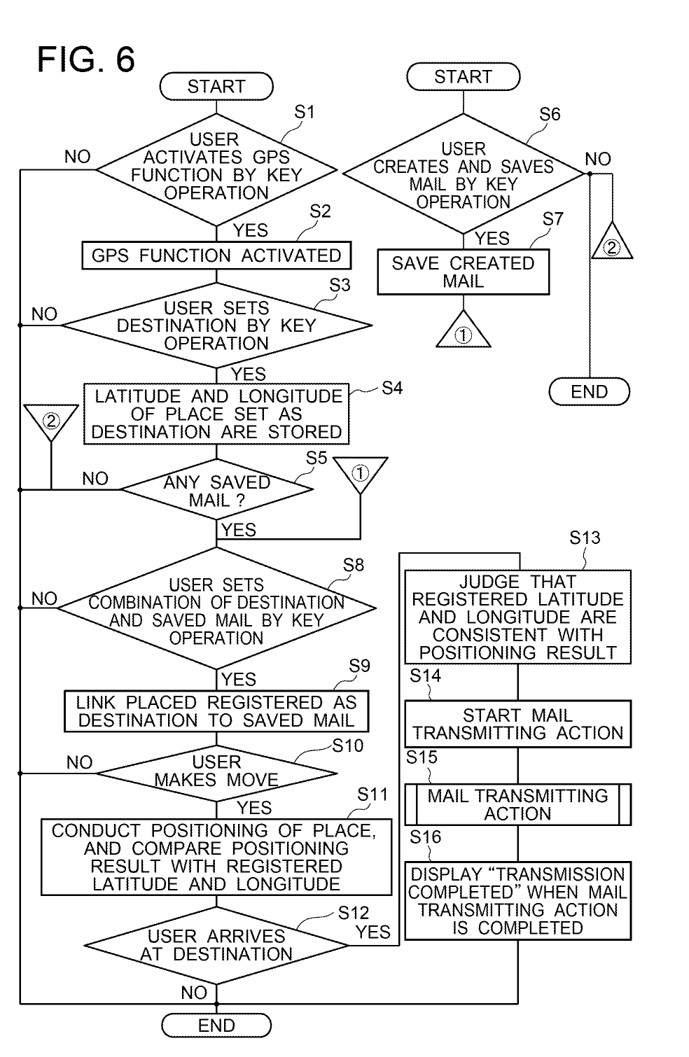

FIG. 7 is a block diagram showing a schematic illustration of functions of an information processing system according to a modification example;

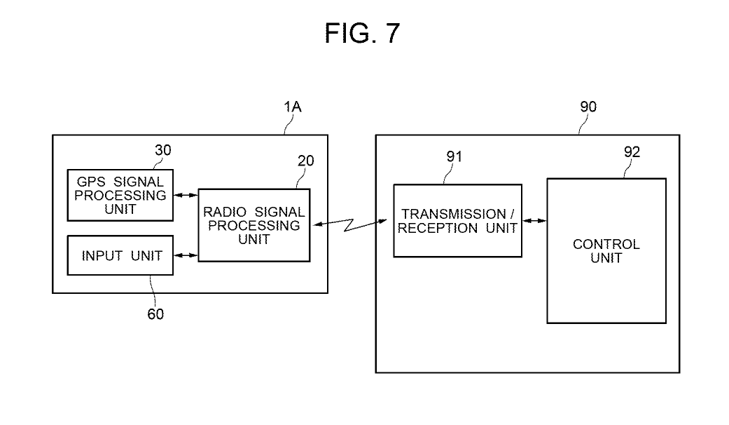

FIG. 8 is a block diagram showing another exemplary embodiment of the invention;

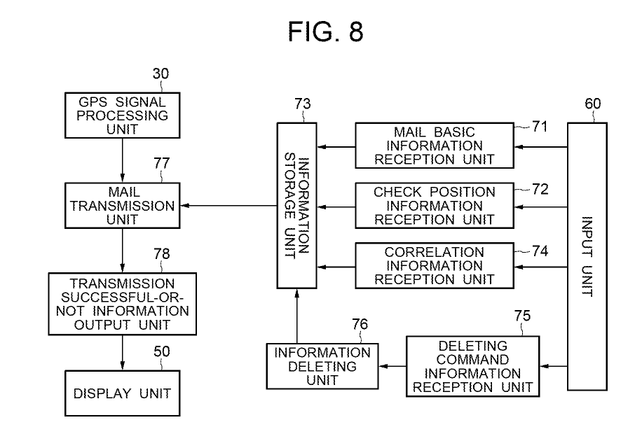

FIG. 9 is a flowchart showing an at-arrival mail transmission program executed by a CPU shown in FIG. 8; and

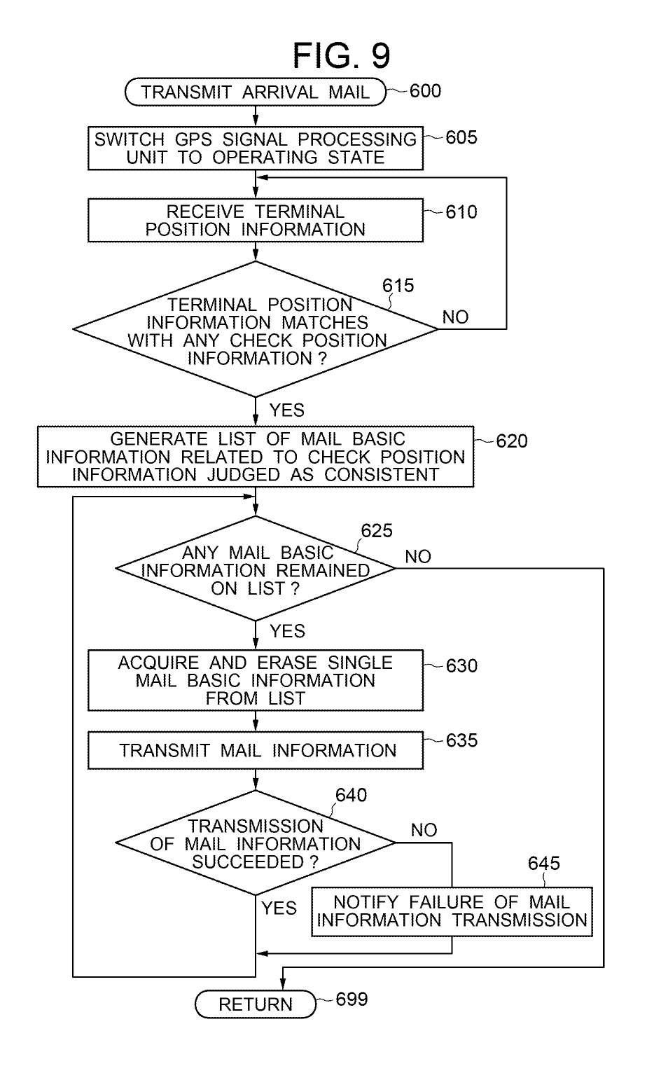

FIG. 10 is a block diagram showing a schematic illustration of functions of the information processing system according to the modification example of the exemplary embodiment shown in FIG. 7.

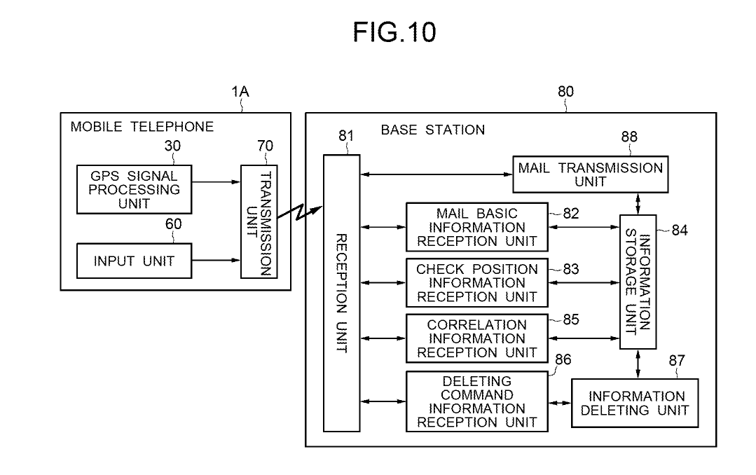

### REFERENCE NUMERALS

1 Mobile telephone
1A Mobile telephone
10 Control unit
11 CPU
12 Memory
20 Radio signal processing unit
Radio antenna
30 GPS signal processing unit
31 GPS antenna
40 Sound signal processing unit
41 Microphone
42 Speaker
50 Input unit
60 Display unit
70 Transmission unit
71 Mail basic information reception unit
72 Check position information reception unit
73 Information storage unit
74 Correlation information reception unit
75 Deleting command information reception unit
76 Information deleting unit
77 Mail transmission unit
78 Transmission successful-or-not information output unit
80 Base station
81 Reception unit
82 Mail basic information reception unit
83 Check position information reception unit
84 Information storage unit
85 Correlation information reception unit
86 Deleting command information reception unit
87 Information deleting unit
88 Mail transmission unit
301-305 Mail basic information
401, 402 Check position information
505 Correlation information

What is claimed is:

1. A mobile terminal having a function of acquiring current position information, comprising:
an information storage device which stores position information of a destination, contents information showing a condition of the mobile terminal at a position of the destination, and information of a mail address of a transmission partner in a related manner;
a current position information monitoring device which compares the position information of the destination set in advance with current position information, and outputs a matching signal when the both match with each other; and
a communication control unit which controls to transmit the position information of the destination and the contents information showing the condition of the mobile terminal at the destination to the mail address based on the matching signal outputted from the current position information monitoring device, wherein
the current position information monitoring device and the communication control unit start to activate by having activation of a current position information positioning function of the mobile terminal as a trigger.

2. The mobile terminal as claimed in claim 1, comprising:
a mail basic information reception unit which receives the contents information showing the condition of the mobile terminal at the destination, and stores the contents information to the information storage device; and
a check position information reception unit which receives the position information of the destination, and stores the position information to the information storage device.

3. The mobile terminal as claimed in claim 2, wherein
the check position information reception unit converts the position information of the mobile terminal at the destination to information of latitude and longitude, and stores the converted information to the information storage device.

4. The mobile terminal as claimed in claim 2, comprising
a correlation information reception unit which links and stores, to the information storage device, the contents information received by the mail basic information reception device and the position information of the mobile terminal at the destination received by the check position information reception unit.

5. The mobile terminal as claimed in claim 4, wherein
the correlation information reception unit links the contents information to position information of a plurality of destinations.

6. The mobile terminal as claimed in claim 4, wherein
the correlation information reception unit links plural pieces of contents information to position information of a single destination.

7. The mobile terminal as claimed in claim 1, comprising
a transmission successful-or-not information output unit which monitors whether or not mail transmission under a communication control done by the communication control unit is succeeded.

8. The mobile terminal as claimed in claim 1, wherein
the information storage device validly stores the stored destination position information, the contents information, and linkage between the position information and the contents information until setting thereof is terminated.

9. A communication system, comprising a mobile terminal and an information processing device which communicates with the mobile terminal, wherein:
the mobile terminal has a function of acquiring position information of a destination and current position information of the mobile terminal and transmitting the acquired information to the information processing device; and
the information processing device comprises
an information storage device which stores the position information of the destination transmitted from the mobile terminal, contents information showing a condition of the mobile terminal at a position of the destination, and information of a mail address of a transmission partner in a related manner,
a current position information monitoring device which compares the position information of the destination set in advance with current position information, and outputs a matching signal when the both match with each other, and
a communication control unit which transmits the position information of the destination and the contents information showing the condition of the mobile terminal at the destination to the mail address based on the matching signal outputted from the current position information monitoring device, wherein
the current position information monitoring device and the communication control unit start to activate by having activation of a current position information positioning function of the mobile terminal as a trigger.

10. The communication system as claimed in claim 9, wherein
the information processing device comprises:
a mail basic information reception unit which receives the contents information showing the condition of the mobile terminal at the destination, and stores the contents information to the information storage device; and
a check position information reception unit which receives the position information of the destination, and stores the position information to the information storage device.

11. The communication system as claimed in claim 10, comprising
a correlation information reception unit which links and stores, to the information storage device, the contents information received by the mail basic information reception device and the position information of the mobile terminal at the destination received by the check position information reception unit.

12. A communication method for conducting communication by using a mobile terminal having a function of acquiring current position information, the method executing:
processing which compares position information of a destination set in advance with the current position information, and outputs a matching signal when the both match with each other;
processing which transmits the position information of the destination and contents information showing a condition of the mobile terminal at the destination to a mail address based on the matching signal; and
processing which starts the processing by having activation of a current position information positioning function of the mobile terminal as a trigger.

13. The communication method as claimed in claim 12, comprising
linking the contents information to the position information of the mobile terminal.

14. The communication method as claimed in claim 13, comprising
linking the contents information to position information of a plurality of destinations.

15. The communication method as claimed in claim 13, comprising
linking plural pieces of contents information to position information of a single destination.

16. A computer readable recording medium storing a communication program for controlling communication conducted by using a mobile terminal having a function of acquiring current position information, the program causing a computer to execute:
a function which compares position information of a destination set in advance with the current position information, and outputs a matching signal when the both match with each other;
a function which transmits the position information of the destination and contents information showing a condition of the mobile terminal at the destination to a mail address based on the matching signal; and
a function which starts the functions by having activation of a current position information positioning function of the mobile terminal as a trigger.

17. The computer readable recording medium storing the communication program as claimed in claim 16, which causes the computer to execute a function which links the contents information to the position information of the mobile terminal.

18. The computer readable recording medium storing the communication program as claimed in claim 17, which causes the computer to execute a function which links the contents information to position information of a plurality of destinations.

19. The computer readable recording medium storing the communication program as claimed in claim 17, which causes the computer to execute a function which links plural pieces of contents information to position information of a single destination.

20. A mobile terminal having a function of acquiring current position information, comprising:
information storage means for storing position information of a destination, contents information showing a condition of the mobile terminal at a position of the destination, and information of a mail address of a transmission partner in a related manner;
current position information monitoring means for comparing the position information of the destination set in advance with current position information, and outputting a matching signal when the both match with each other; and
communication control means for controlling to transmit the position information of the destination and the contents information showing the condition of the mobile terminal at the destination to the mail address based on the matching signal outputted from the current position information monitoring means, wherein
the current position information monitoring means and the communication control means start to activate by having activation of a current position information positioning function of the mobile terminal as a trigger.
